(19) United States
(12) Patent Application Publication
(10) Pub. No.: US 2022/0411151 A1
(43) Pub. Date: Dec. 29, 2022

(54) Wire Management Device and System

(71) Applicant: Michael A. Gladkin, Scottsdale, AZ (US)

(72) Inventor: Michael A. Gladkin, Scottsdale, AZ (US)

(21) Appl. No.: 17/565,722

(22) Filed: Dec. 30, 2021

Related U.S. Application Data
(60) Provisional application No. 63/215,436, filed on Jun. 26, 2021.

(51) Int. Cl. B65D 63/10; H02G 3/00

(52) U.S. Cl. CPC B65D 63/1081; H02G 3/263

(57) ABSTRACT

The present invention is a wire management device and system comprising a locking head and an elongated strap extending downwardly from a bottom of the locking head and configured to feed through a locking mechanism in the locking head to form a first fixed loop. The elongated strap comprises a length of material, a plurality of stops spaced evenly along the length of material and configured to prevent the elongated strap from moving through the through hole, and a plurality of ridges spaced evenly between the plurality of stops. The locking mechanism is configured to engage the plurality of ridges to allow the elongated strap to move in one direction through the locking mechanism and prevent the elongated strap from moving in an opposite direction. The plurality of stops are configured to prevent the elongated strap from moving further through the locking head.

### CROSS REFERENCE TO RELATED APPLICATIONS

The present application is related to and claims priority from prior provisional patent application Ser. No. 63/215,436 filed on Jun. 26, 2021, entitled “WIRE MANAGEMENT SYSTEM”, the contents of all of which are incorporated herein by this reference and are not admitted to be prior art with respect to the present invention by the mention in this cross reference section.

### BACKGROUND OF THE INVENTION

The present invention generally relates to wire and cable management, and more specifically to a solar wire management system. Ground-Mount Solar Photovoltaic (PV) systems are a common energy generation means for Utility-Scale Energy production providing both Transmission and Distribution level power to the US and Global Electrical Grids. Utility-Scale ground-mount solar PV systems utilize specific equipment from many producers of Fixed Tilt (FT) and Single Axis Tracking (SAT) structural racking systems as well as solar modules in which the solar modules are mechanically attached to FT or SAT racking structures in specific configurations. These solar modules are then electrically connected to each other as strings. The electrical conductors that comprise these strings run across the solar modules or along the racking structure and typically parallel to the racking structure and are secured or supported to prevent the conductors from loosely hanging off the structure and becoming damaged through the course of the PV system's lifetime.

A typical configuration of a single row of modules will be arranged in portrait or landscape orientation with 26-28 modules per module string and 3 strings per row. A typical structural row of solar modules is made of steel and approximately 300 ft long.

Module frames are typically constructed of aluminum, are secured to the structural racking systems using module interface brackets with accompanying hardware. Typically, mounting holes in the bottom of the module frame rails are commonly used as the mechanical fastening surface to perform module lead and dc homerun level wire management, preventing wiring from hanging down off the structure as the wiring traverses the structure of the solar tracker or fixed tilt row towards the combiner boxes or solar inverters. DC Homerun wiring is a commonly used term where the end of a module string is connected to higher voltage PV wire and the wiring that runs from end of module string to the combiner box or inverter is referred to as the DC homerun.

It is common practice that cable ties, clips, solar e-clips, and straps are utilized as the means to support and secure the module to module (string) leads and the dc homerun wiring traversing underneath the modules of the row to the point of entering the ground as underground cable, or on an above grade cable management (CAB) system or directly into a combiner box or string inverter cabinet. The runs of cabling on each row are typically the length of the row sometimes up to 300 ft.

Cable ties are commonly looped through the holes in the bottom frame rail of the module to perform the cable management of the module to module strings and the dc homerun wiring. Utilizing a sole cable tie passing through the hole of the module frame is problematic for cable management as the frame edge of the hole tends to serrate and cut through the cable tie due to wind loading, harmonics on the solar row due to wind, and other mechanical forces over time.

Cable ties can be secured tightly against the cabling and the module frame. By tightly securing a bundle of cables, a common field failure of breakage occurs as the bundle of cables thermally cycles and applies axial and torsional loads on the tightened cable tie throughout the seasons. Other securing means such as press on frame clips, that use a cable tie as its securing means for the cables, share a similar problem. These press on frame clips will rip off the frame rail if the cable tie that bundles the dc homerun wiring is completely secured or the cable becomes hung up and thermal cycling occurs. Fir trees (a commonly used term describing the shape of these components) that are pressed into the holes of the solar module have a similar issue as the others, all resulting in failure through thermal cycling.

One known proper installation method to prevent failure due to thermal cycling of the DC homerun cable is to support the cabling without completely tightening the cable tie around the bundle of the pv wires, leaving a gap so that the cable can expand and contract without putting an unintended mechanical load on the cable ties. Dowels and other tools are commonly used to create a standardized gap between the cabling and the inner diameter of the cable management strap or tie.

Construction and field installation of the wire management and the utilization of serrated cable ties causes issues with over tightening thereby leading to failure of the part. A cable tie with a serrated tie running the entire length of the part introduces the ability for variability in installation from worker to worker and is very difficult to control for thousands of these components being installed on a typical PV system. It is likely that if one cable tie on a single row fails, it can lead to failure of the other cable ties in the row due to increased loading that occurs on the remaining ties in the row.

During construction there is commonly installation in multiple phases where the DC homerun wiring is installed but not terminated. This mock-up installation or pre-installation commonly means that cable ties are installed and then cut off during final termination of the wiring in which the part is wasted and another is required. This leads to materials waste as a typical cable tie is not reusable once secured. Companies have started to leave them loose to try and get multiple uses out of them, but this has been problematic due to variability in training and installation of the cable tie. Therefore, a cable tie is typically viewed as a single use item in the utility scale solar industry leading to added a lot of waste and cost for stakeholders of the PV systems.

Assemblies of parts are common in the industry where multiple separate components are required for cable management. Some examples of these include the solar e-clip and cable tie, hellerman tyton's button and cable tie, the fir tree and cable tie, and so on and so forth.

The present invention overcomes the problems cited above by providing an improved wire management device and system.

### BRIEF SUMMARY OF THE INVENTION

It is an object of the present invention to provide a wire management device and system comprising a locking head and an elongated strap extending downwardly from a bottom of the locking head and configured to feed through a locking mechanism in the locking head to form a first fixed loop.

It is another object of the present invention to provide a wire management device and system where the elongated strap comprises a length of material extending from a bottom of the body, a plurality of stops spaced evenly along the length of material and configured to prevent the elongated strap from moving through the through hole, and a plurality of ridges spaced evenly between the plurality of stops.

It is another object of the present invention to provide a wire management device and system where the locking mechanism is configured to engage the plurality of ridges to allow the elongated strap to move in one direction through the locking mechanism and prevent the elongated strap from moving in an opposite direction.

It is another object of the present invention to provide a wire management device and system where the plurality of stops are configured to prevent the elongated strap from moving further through the locking head such that the strap forms a first fixed loop.

It is another object of the present invention to provide a wire management device and system where the elongated strap can be cut and reinserted into the locking mechanism for form a second fixed loop.

It is another object of the present invention to provide a wire management device and system where the first fixed loop and the second fixed loop are configured to encircle a bundle of wires where the diameters of the first fixed loop and second fixed loop are larger than the diameter of the bundle of wires.

It is another object of the present invention to provide a method of using a wire management device comprising the steps of inserting a wire management device into a hole in a structural frame member of a structural solar racking system; looping the elongated strap of the wire management device around a bundle of wires located below the structural frame member; and feeding the elongated strap through the through hole until the plurality of ridges engage the locking mechanism and the plurality of stops prevents the elongated strap from moving further through the through hole to form a first fixed loop around the bundle of wires.

### BRIEF DESCRIPTION OF THE DRAWINGS

The particular objects and features of the invention as well as the advantages will become apparent from the following description taken in connection with the accompanying drawings in which:

FIG. 1 is a perspective view of a WIRE MANAGEMENT DEVICE AND SYSTEM according to an embodiment of the present invention.

FIG. 2 is a perspective view of a WIRE MANAGEMENT DEVICE AND SYSTEM according to an embodiment of the present invention.

FIG. 3 is a close up perspective view of the locking head of a WIRE MANAGEMENT DEVICE AND SYSTEM according to an embodiment of the present invention.

FIG. 4 is a cut-away side view of a locking mechanism for a WIRE MANAGEMENT DEVICE AND SYSTEM according to an embodiment of the present invention.

FIGS. 5A and 5B are a series of illustrations showing installation of the WIRE MANAGEMENT DEVICE AND SYSTEM according to an embodiment of the present invention.

### DETAILED DESCRIPTION OF THE INVENTION

The following description of the preferred embodiments of the invention is intended to enable someone skilled in the prior art to make and use this invention but is not intended to limit the invention to these preferred embodiments.

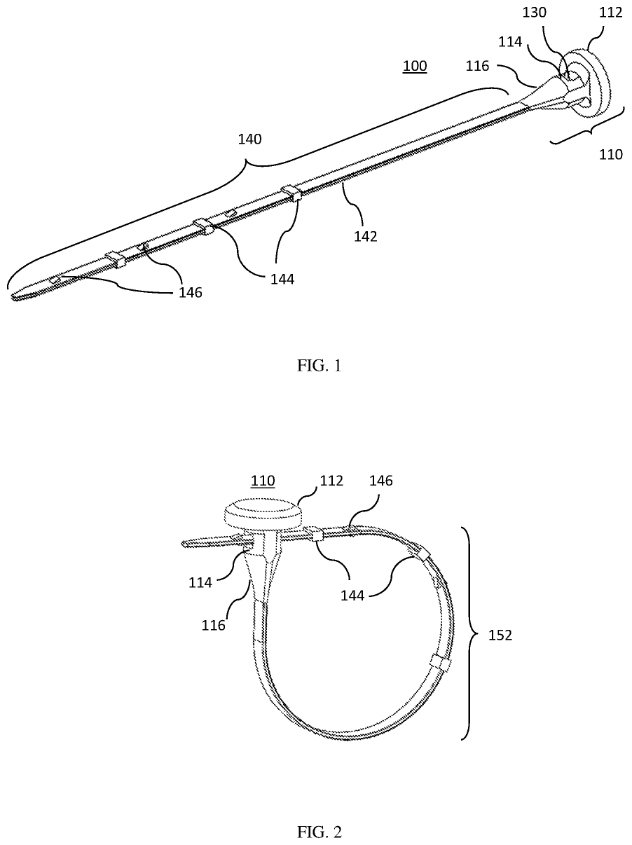

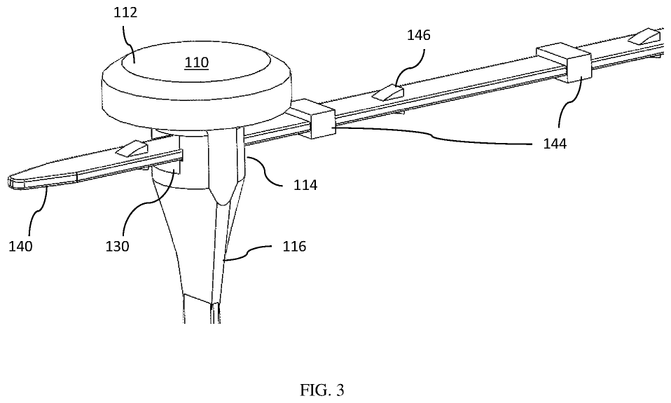

Now referring to the attached drawings, FIGS. 1-4 show the present invention is a wire management device 100 comprising a locking head 110 and an elongated strap 140, wherein the elongated strap 140 is configured to feed through the locking head 110 to form a plurality of fixed loops 150 configured to encircle a wire bundle. Each of the plurality of fixed loops 150 is configured to be larger than the wire bundle and the interaction between the elongated strap 140 and the locking head 110 is configured to prevent the elongated strap 140 from being cinched tight around the wire bundle.

As shown in FIGS. 1-4, the wire management device 100 comprises a locking head 110 comprising a top 112 and a body 114 extending downwardly from the top 112, wherein the top 112 is a larger diameter than the body 114. The body preferably comprises a locking mechanism 120 positioned within a through hole 130. The elongated strap 140 comprises a length of material 142 extending away from a bottom 116 of the body 114, a plurality of stops 144 spaced evenly along the length of material 142 and configured to prevent the strap from moving through the horizontal hole 130, and a plurality of ridges 146 spaced evenly between the plurality of stops 144.

As further shown in FIGS. 1-4, the locking head 110 body 114 is preferably a cylinder further comprising a top surface and a bottom surface. The top 112 is preferably centered on the body 114 top surface and is preferably a larger diameter than the body 114 such that when inserted into a hole or slot in a frame of a solar panel array, the wire management device 100 is held in place by the top 112. The bottom 116 of the body preferably extends downwardly in a conical shape.

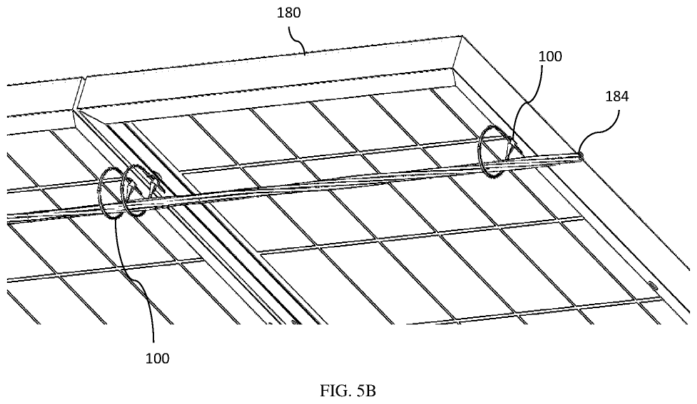

As shown in FIGS. 5A and 5B, the body 114 of the wire management device 110 is configured to fit within a hole or slot 182 in the structural solar racking system 180, such as the structural frame members running under the solar module, such that the top 112 of the wire management device 110 is larger than the hole or slot 182 to prevent the wire management device 110 from falling through the hole or slot. The wire management device 110 is preferably comprised of a plastic material resistant to abrasion. For example, when the wire management device 110 moves within the hole/slot 182 the edges of the hole/slot 182 will not cut through the body 114 of the wire management device 110. However, other abrasion-resistant materials not mentioned herein may be considered.

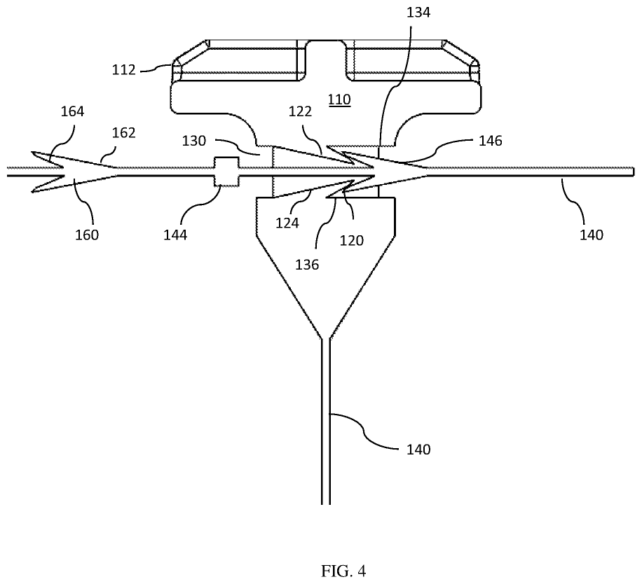

As further shown in FIGS. 1-4, the body 114 preferably further comprises a through hole 130 extending generally horizontally from a first side of the body 114 to a second side of the body 114, where the second side is opposite the first side. As shown in FIG. 3, the locking mechanism 120 is positioned within the through hole 130 and is preferably configured to allow the elongated strap 140 to move through the locking mechanism 120 in one direction but prevent the elongated strap 140 from moving in an opposite direction.

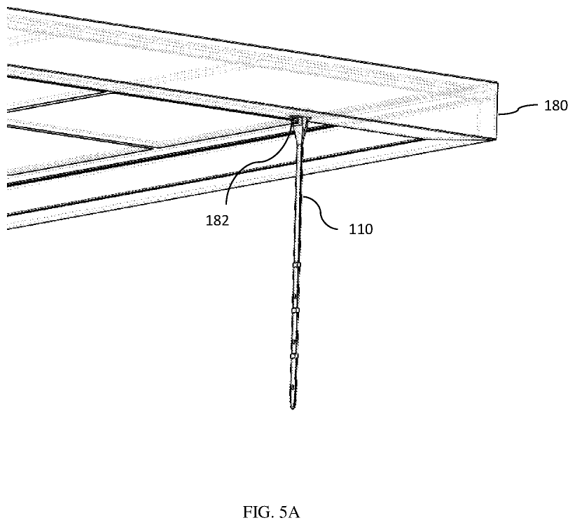

In one embodiment, as further shown in FIG. 4, the locking mechanism 120 preferably comprises a first flap 122 flexibly attached to an upper surface of the through hole 130 and extending downward at an angle from the upper surface 134 of the through hole 130. The first flap 122 is preferably configured to interact with the plurality of ridges 146 as the elongated strap 140 moves through the locking mechanism 120. In this embodiment, the plurality of ridges 146 preferably pushes the first flap 122 upwardly as the elongated strap 140 moves through the locking mechanism 120. However, if the elongated strap moves in the opposite direction, then the first flap 122 springs back down toward the elongated strap 140 such that the plurality of ridges 146 abuts the first flap 122 to prevent the elongated strap 140 from moving backwards through the locking mechanism 120 and through hole.

In another embodiment, the locking mechanism 120 preferably further comprises a second flap 124 flexibly attached to a lower surface 136 of the through hole 130 opposite the first flap 122. In this embodiment, the second flap 124 extends at an angle upwardly from the lower surface 136 of the through hole 130. In this embodiment, the second flap 124 preferably extends towards the first flap 122 and in the same direction as the first flap 122. In this embodiment, the elongated strap 140 preferably further comprises a plurality of upper ridges and a plurality of lower ridges configured to interact with the first and second flaps respectively.

As shown in FIGS. 1-4, the elongated strap 140 is preferably comprised of a length of material 142 that is relatively flat, where the width of the length of material 142 is greater than the thickness. In one embodiment as shown in FIGS. 1-4, each of the plurality of ridges 146 preferably comprise a fin 160 extending upwardly from the length of material 142. The fin 160 preferably comprises an angled front edge 162 and a back edge 164, where the angled front edge 162 faces toward an end of the elongated strap 140 and is configured to push the first or second flap of the locking mechanism 120 toward the surface of the through hole 130 the first or second flap extends from. The back edge 164 of the fin 160 is configured to prevent the elongated strap 140 from moving back through the locking mechanism 120 by interacting with the first or second flap which has extended back into the through hole 120 toward the elongated strap 140 after the fin 160 passes the first or second flap. In one embodiment, the back edge 164 is vertical. In another embodiment, the back edge 164 is configured to angle back toward the angled front edge 162.

As further shown in FIGS. 1-4, the plurality of stops 144 are preferably configured to prevent the elongated strap 140 from entering the through hole 130. In one embodiment, each of the plurality of stops 144 are preferably configured such that half of the stop extends away from each surface of the length of material 142. In another embodiment, each of the plurality of stops 144 extends away from one surface of the length of material 142. In another embodiment, the plurality of stops 144 are shaped as spheres. In another embodiment, the plurality of stops 144 are shaped as cubes. Other shapes may be contemplated for the plurality of stops 144 not described herein.

In one embodiment, the body 114 further comprises a recess at an opening to the through hole 130. The recess is preferably configured to match the shape of the plurality of stops 144. The recess is configured to allow at least one of the plurality of stops 144 to partially enter the recess and then prevent the elongated strap 140 from moving further through the through hole 130.

The plurality of ridges 146 are preferably spaced evenly along the length of material 142 of the elongated strap 140. Additionally, the plurality of stops 144 are also spaced evenly along the length of material 142 in between the plurality of ridges 146. As shown in FIGS. 1-4, each of the plurality of stops 144 are positioned between each of the plurality of ridges 146. Further, each of the plurality of ridges 146 are in line before each of the plurality of stops 144 starting at an end of the elongated strap 140.

As shown in FIGS. 1-5, the wire management device 110 is configured such that the elongated strap 140 is fed through the locking mechanism 120 to form a first fixed loop 152 around a bundle of wires 184. The first fixed loop 152 is configured to be formed due to the placement of the plurality of stops 144 and the plurality of ridges 146 along the elongated strap 140. The first fixed loop 152 allows the bundle of wires 184 to be held in place and allow movement without straining or breaking the elongated strap 140. The configuration of the elongated strap 140 prevents the first fixed loop 152 from being cinched tight around the bundle of wires 184.

Additionally, the wire management device 110 is configured to allow the elongated strap 140 to be used multiple times by cutting the length of material 142 between each of the plurality of ridges 146 and each of the plurality of stops 144, then reinserting the elongated strap 140 through the through hole 130 until a second individual stop buts up against the body 114 thus providing a second fixed loop 154 around the bundle of wires 184. This second fixed loop 154 is also configured to be larger than the bundle of wires 184 to allow movement of the bundle of wires 184 within the second fixed loop 154 and without cinching the elongated strap 140 tight around the bundle of wires 184. However, the second fixed loop 154 will be smaller in diameter than the first fixed loop 152.

A method of using a wire management device to control a bundle of wires between solar modules, comprising the steps of inserting a wire management device, as described in the above paragraphs, into a hole in a structural frame member of the solar module, where the wire management device comprises a locking head configured to fit in the hole; looping the elongated strap around the wire bundle located below the structural frame member; and feeding the elongated strap through the through hole until the plurality of ridges engage the locking mechanism and the plurality of stops prevents the elongated strap from moving further through the through hole to form a first fixed loop around the bundle of wires.

The method further comprises the step of cutting the elongated strap to remove the first fixed loop and release the bundle of wires; looping the elongated strap around the bundle of wires a second time; and feeding the elongated strap through the through hole until the plurality of ridges engage the locking mechanism and the plurality of stops prevents the elongated strap from moving further through the through hole to form a second fixed loop around the bundle of wires.

The step of cutting the elongated strap further comprises cutting the strap on both sides of the previous stop such that the next ridge of the plurality of ridges is available to engage the locking mechanism when the elongated strap is fed through the through hole.

The steps of cutting the elongated strap and looping the elongated strap around the bundle of wires can be repeated as many times as there are sets of the plurality of ridges and the plurality of stops along the length of material. Thus, the wire management system creates a reusable wire management device and elongated strap that does not have to be replaced every time a solar module is worked on.

Although the present invention has been described by way of example, it should be appreciated that variations and modifications may be made without departing from the scope of the invention. Furthermore, where known equivalents exist to specific features, such equivalents are incorporated as if specifically referred to in this specification.

I claim:

1. A wire management device comprising:
a locking head comprising a top and a body extending downwardly from the top, wherein the top is a larger diameter than the body, the body comprising a locking mechanism positioned within a through hole; and
an elongated strap comprising a length of material extending from a bottom of the body, a plurality of stops spaced evenly along the length of material and configured to prevent the elongated strap from moving through the through hole, and a plurality of ridges spaced evenly between the plurality of stops;
wherein the locking mechanism is configured to engage the plurality of ridges to allow the elongated strap to move in one direction through the locking mechanism and prevent the elongated strap from moving in an opposite direction; and
wherein the plurality of stops are configured to prevent the elongated strap from moving further through the locking head such that the strap forms a first fixed loop.

2. The wire management device of claim 1, wherein the locking mechanism comprises a first flap flexibly attached to an upper surface of the through hole and extending downward at an angle from the upper surface of the through hole.

3. The wire management device of claim 2, further comprising a second flap flexibly attached to a lower surface of the through hole and extending upwardly at an angle from the lower surface of the through hole.

4. The wire management device of claim 3, wherein the first flap and the second flap are configured to interact with the plurality of ridges on the elongated strap.

5. The wire management device of claim 1, wherein a second fixed loop smaller in diameter than the first fixed loop is formed when the elongated strap is cut and reinserted into the through hole, and a third fixed loop smaller in diameter than the second fixed loop when the elongated strap is cut and reinserted into the through hole.

6. The wire management device of claim 1, wherein the plurality of ridges comprise a first fin extending from a first side of the elongated strap.

7. The wire management device of claim 6, wherein the plurality of ridges further comprise a second fin extending from a second side of the elongated strap, wherein the second side of the elongated strap is opposite the first side.

8. The wire management device of claim 1, wherein the body is cylindrical and configured to fit into a hole in a frame member for a solar panel array.

9. The wire management device of claim 1, wherein the bottom of the locking head is a cone.

10. The wire management device of claim 1, wherein the first fixed loop is a diameter larger than a bundle of wires being encircled by the first fixed loop.

11. A wire management system, comprising:
a solar panel module comprising a solar panel array and a frame supporting the solar panel array;
a locking head comprising a top and a body extending downwardly from the top, wherein the top is a larger diameter than the body, the body comprising a locking mechanism positioned within a through hole; and
an elongated strap comprising a length of material extending from a bottom of the body, a plurality of stops spaced evenly along the length of material and configured to prevent the elongated strap from moving through the through hole, and a plurality of ridges spaced evenly between the plurality of stops;
wherein the locking mechanism is configured to engage the plurality of ridges to allow the elongated strap to move in one direction through the locking mechanism and prevent the elongated strap from moving in an opposite direction; and
wherein the plurality of stops are configured to prevent the elongated strap from moving further through the locking head such that the elongated strap forms a first fixed loop.

12. The wire management system of claim 11, wherein the locking mechanism comprises a first flap flexibly attached to an upper surface of the through hole and extending downward at an angle from the upper surface of the through hole.

13. The wire management device of claim 12, further comprising a second flap flexibly attached to a lower surface of the through hole and extending upwardly at an angle from the lower surface of the through hole.

14. The wire management device of claim 13, wherein the first flap and the second flap are configured to interact with the plurality of ridges on the elongated strap.

15. The wire management device of claim 11, wherein the plurality of ridges comprises a first fin extending from a first side of the elongated strap.

16. The wire management device of claim 15, wherein the plurality of ridges further comprises a second fin extending from a second side of the elongated strap, wherein the second side of the elongated strap is opposite the first side.

17. The wire management device of claim 11, wherein the first fixed loop is a diameter larger than a bundle of wires being encircled by the first fixed loop.

18. A method of using a wire management system to control a bundle of wires between solar modules, comprising the steps of:
inserting a wire management device into a hole in a structural frame member of a solar module, the wire management device comprising: a locking head configured to fit in the hole, the locking head comprising a top and a body extending downwardly from the top, wherein the top is a larger diameter than the body, the body comprising a locking mechanism positioned within a through hole; and
an elongated strap comprising a length of material extending downwardly from a bottom of the body, a plurality of stops spaced evenly along the length of material and configured to prevent the elongated strap from moving through the through hole, and a plurality of ridges spaced evenly between the plurality of stops;
wherein the locking mechanism is configured to engage the plurality of ridges to allow the elongated strap to move in one direction and prevent the elongated strap from moving in an opposite direction; and
wherein the plurality of stops are configured to prevent the elongated strap from moving further through the locking head such that the elongated strap forms a first fixed loop;
looping the elongated strap of the wire management device around a bundle of wires located below the structural frame member; and
feeding the elongated strap through the through hole until the plurality of ridges engage the locking mechanism and the plurality of stops prevents the elongated strap from moving further through the through hole to form a first fixed loop around the bundle of wires.

19. The method of using a wire management system of claim 18, further comprising the steps of:
cutting the elongated strap to remove the first fixed loop and release the bundle of wires;
looping the elongated strap of the wire management device around the bundle of wires; and
feeding the elongated strap through the through hole until the plurality of ridges engage the locking mechanism and the plurality of stops prevents the elongated strap from moving further through the through hole to form a second fixed loop around the bundle of wires.

20. A method of using a wire management system to control a bundle of wires, comprising the steps of:
inserting a wire management device into a hole in a structural frame member of a structural solar racking system, the wire management device comprising: a locking head configured to fit in the hole, the locking head comprising a top and a body extending downwardly from the top, wherein the top is a larger diameter than the body, the body comprising a locking mechanism positioned within a through hole; and an elongated strap comprising a length of material extending downwardly from a bottom of the body, a plurality of stops spaced evenly along the length of material and configured to prevent the elongated strap from moving through the through hole, and a plurality of ridges spaced evenly between the plurality of stops;
wherein the locking mechanism is configured to engage the plurality of ridges to allow the elongated strap to move in one direction and prevent the elongated strap from moving in an opposite direction; and
wherein the plurality of stops are configured to prevent the elongated strap from moving further through the locking head such that the elongated strap forms a first fixed loop;
looping the elongated strap of the wire management device around a bundle of wires located below the structural frame member; and
feeding the elongated strap through the through hole until the plurality of ridges engage the locking mechanism and the plurality of stops prevents the elongated strap from moving further through the through hole to form a first fixed loop around the bundle of wires.
